(19) United States
(12) Patent Application Publication
(10) Pub. No.: US 2013/0155883 A1
(43) Pub. Date: Jun. 20, 2013

(54) METHOD AND APPARATUS FOR PERFORMING FREQUENCY SCAN FOR WIRELESS SYSTEMS WITH VARIABLE CHANNEL BANDWIDTH

(71) Applicants: Supratik Bhattacharjee, San Diego, CA (US); Shivratna G. Srinivasan, San Diego, CA (US); Brian C. Banister, San Diego, CA (US); Hisham Mahmoud, San Diego, CA (US)

(72) Inventors: Supratik Bhattacharjee, San Diego, CA (US); Shivratna G. Srinivasan, San Diego, CA (US); Brian C. Banister, San Diego, CA (US); Hisham Mahmoud, San Diego, CA (US)

(73) Assignee: QUALCOMM Incorporated, San Diego, CA (US)

(21) Appl. No.: 13/610,652

(22) Filed: Sep. 11, 2012

Related U.S. Application Data
(60) Provisional application No. 61/576,242, filed on Dec. 15, 2011.

(51) Int. Cl. H04W 48/16; H04J 3/00; H04W 24/00

(52) U.S. Cl. 370/252; 370/328; 370/277; 370/280

(57) ABSTRACT

Techniques for performing a frequency scan to detect wireless systems operating on frequency channels with variable bandwidths are disclosed. In one aspect, a user equipment (UE) performs a frequency scan for a plurality of frequency channels and measures the received power of each frequency channel based on a center frequency and a bandwidth of the frequency channel. The UE identifies candidate frequency channels for acquisition based on the results of the frequency scan. In another aspect, a frequency scan of a band is performed by partitioning the band into multiple segments, measuring received powers of subcarriers or raster frequencies within each segment, and concatenating received powers of subcarriers or raster frequencies for all segments. A frequency scan is then performed based on the concatenated results for the multiple segments.

The present application claims priority to U.S. Provisional Patent Application Ser. No. 61/576,242, entitled “METHOD AND APPARATUS OF FREQUENCY SCAN FOR DETERMINING CARRIER FREQUENCY OF WIRELESS SYSTEM WITH VARIABLE BANDWIDTH,” filed Dec. 15, 2011, assigned to the assignee hereof and incorporated herein by reference in its entirety.

### BACKGROUND

I. Field

The present disclosure relates generally to communication, and more specifically to techniques for performing a frequency scan.

II. Background

Wireless communication systems are widely deployed to provide various types of communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A UE may be capable of communicating with one or more wireless systems on one or more frequency bands (or simply, bands). The UE may perform a system search upon being powered on in order to detect a wireless system from which the UE can obtain communication service. For a system search, the UE may perform a frequency scan of a band and may evaluate each possible frequency channel on which a wireless system might operate. There may be many frequency channels to evaluate in the band, and the frequency scan may be time consuming. Furthermore, the UE may need to perform a frequency scan for many bands, which may greatly extend system search time.

### SUMMARY

Techniques for efficiently performing a frequency scan are disclosed herein. Wireless systems may operate on frequency channels with variable bandwidths, which may be configured by service providers. In one aspect of the present disclosure, a frequency scan may be performed by taking into account the bandwidths of frequency channels. This may improve system detection accuracy.

In one design, a UE may perform a frequency scan for a plurality of frequency channels based on a center frequency and a bandwidth of each frequency channel. For the frequency scan, the UE may measure the received power of each frequency channel based on the center frequency and the bandwidth of the frequency channel. The UE may identify candidate frequency channels for acquisition based on the results of the frequency scan.

In another aspect of the present disclosure, a frequency scan of a band may be performed by partitioning the band into multiple segments, measuring the received powers of subcarriers or raster frequencies within each segment, and concatenating received powers of subcarriers or raster frequencies for all segments. A frequency scan may then be performed based on the concatenated results for the multiple segments.

In one design, a UE may determine a band to scan, with the band covering a plurality of raster frequencies. The UE may partition the band into a plurality of segments covering different portions of the band. The UE may determine received powers of a plurality of subcarriers within each of the plurality of segments. The UE may determine received powers of the plurality of raster frequencies within the band based on the received powers of the subcarriers within each of the plurality of segments. The UE may then perform a frequency scan based on the received powers of the plurality of raster frequencies within the band.

Various aspects and features of the present disclosure are described in further detail below.

### BRIEF DESCRIPTION OF THE DRAWINGS

FIG. 1 shows a wireless communication system.

FIGS. 2A and 2B show exemplary frame structures for frequency division duplexing (FDD) and time division duplexing (TDD), respectively.

FIG. 3 shows raster frequencies for a band.

FIG. 4 shows a process for performing a frequency scan by a UE.

FIG. 5 shows a process for performing a partial frequency scan.

FIG. 6 shows a process for performing a full frequency scan.

FIG. 7 shows partitioning of a band into multiple segments.

FIG. 8 shows an example of a full frequency scan for a 60 MHz band.

FIG. 9 shows downsampling from subcarriers to raster frequencies.

FIG. 10 shows computation of received powers for frequency channels.

FIG. 11 shows placement of a measurement window for a frequency channel.

FIG. 12 shows received powers for all possible frequency channels in a band.

FIG. 13 shows sorting of received powers for different frequency channels.

FIG. 14 shows a process for performing a frequency scan by taking into account channel bandwidth.

FIG. 15 shows a process for performing a frequency scan of a band in segments.

FIG. 16 shows an exemplary implementation of an apparatus.

### DETAILED DESCRIPTION

The frequency scan techniques described herein may be used for various wireless communication systems and radio access technologies. The terms “system” and “network” are often used interchangeably. For example, the techniques may be used for CDMA, TDMA, FDMA, OFDMA, SC-FDMA, and other systems. Different systems may implement different radio access technologies. For example, a CDMA system may implement a radio access technology such as Universal Terrestrial Radio Access (UTRA), cdma2000, etc. UTRA includes Wideband CDMA (WCDMA), Low Chip Rate (LCR), and other variants of CDMA. cdma2000 includes IS-2000, IS-95 and IS-856 standards. A TDMA system may implement a radio access technology such as Global System for Mobile Communications (GSM). An OFDMA system may implement a radio access technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA, E-UTRA and GSM are part of Universal Mobile Telecommunication System (UMTS). 3GPP Long Term Evolution (LTE) and LTE-Advanced (LTE-A) are recent releases of UMTS that use E-UTRA. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless systems and radio access technologies mentioned above as well as other wireless systems and radio access technologies. For clarity, certain aspects of the techniques are described below for LTE, and LTE terminology is used in much of the description below.

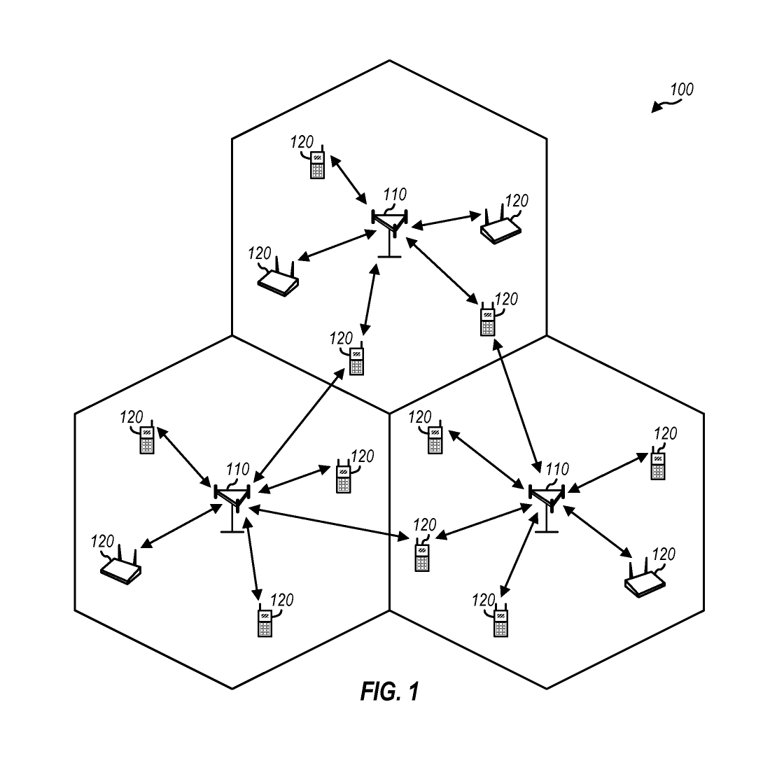

FIG. 1 shows a wireless communication system 100, which may be an LTE system or some other wireless system. Wireless system 100 may include a number of evolved Node Bs (eNBs) 110 and other network entities. An eNB may be an entity that communicates with the UEs 120 and may also be referred to as a base station, a Node B, an access point, etc. Each eNB 110 may provide communication coverage for a particular geographic area and may support communication for the UEs 120 located within the coverage area. To improve system capacity, the overall coverage area of an eNB may be partitioned into multiple (e.g., three) smaller areas. Each smaller area may be served by a respective eNB subsystem. In 3GPP, the term “cell” can refer to a coverage area of an eNB and/or an eNB subsystem serving this coverage area. In general, an eNB may support one or multiple (e.g., three) cells.

UEs 120 may be dispersed throughout the wireless system, and each UE 120 may be stationary or mobile. A UE 120 may also be referred to as a mobile station, a terminal, an access terminal, a subscriber unit, a station, etc. A UE 120 may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc.

Wireless system 100 may utilize frequency division duplexing (FDD) and/or time division duplexing (TDD). For FDD, the downlink and uplink are allocated separate frequency channels, and downlink transmissions and uplink transmissions may be sent concurrently on the separate frequency channels. For TDD, the downlink and uplink share the same frequency channel, and downlink and uplink transmissions may be sent on the same frequency channel in different time intervals.

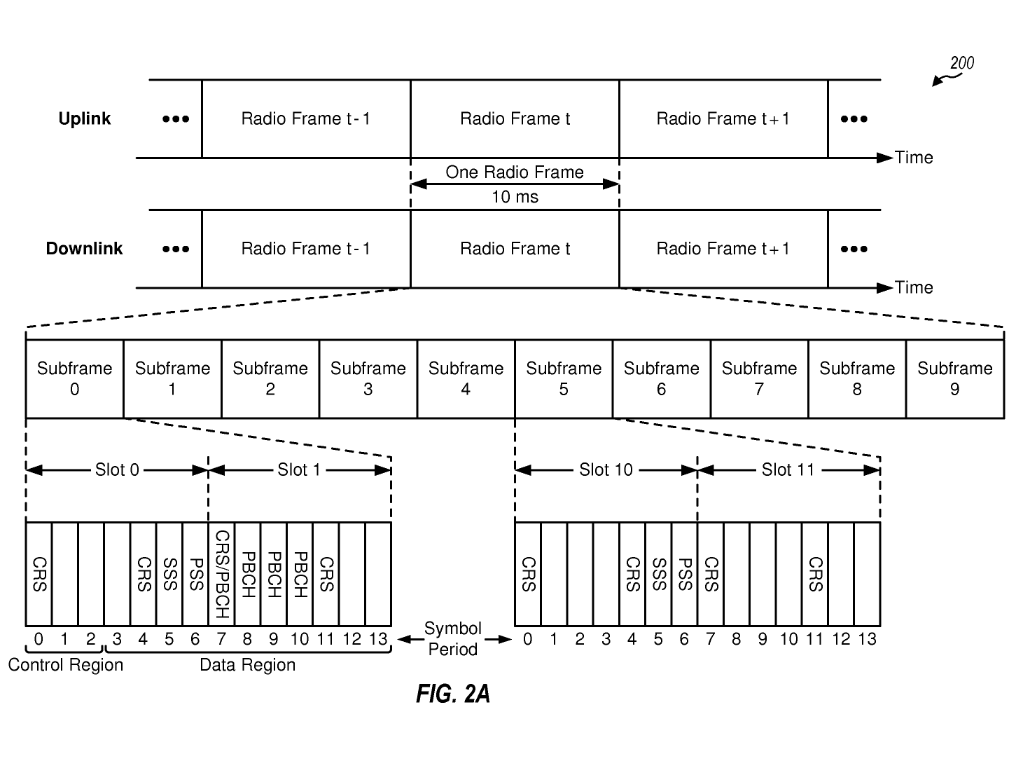

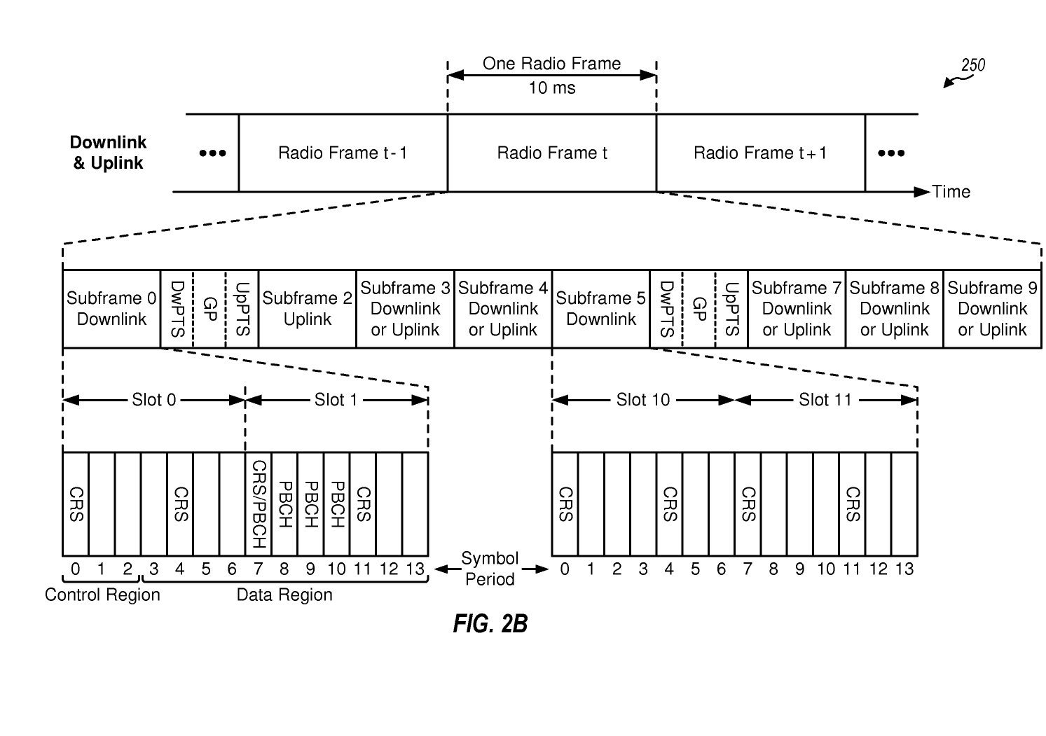

FIG. 2A shows an exemplary frame structure 200 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2A) or six symbol periods for an extended cyclic prefix. The 2 L symbol periods in each subframe may be assigned indices of 0 through 2 L−1.

FIG. 2B shows an exemplary frame structure 250 for TDD in LTE. The transmission timeline for the downlink and uplink may be partitioned into units of radio frames, and each radio frame may be partitioned into 10 subframes with indices of 0 through 9. LTE supports a number of uplink-downlink configurations for TDD. Subframes 0 and 5 are used for the downlink and subframe 2 is used for the uplink for all uplink-downlink configurations. Subframes 3, 4, 7, 8 and 9 may each be used for the downlink or uplink depending on the uplink-downlink configuration. Subframe 1 includes a Downlink Pilot Time Slot (DwPTS), a Guard Period (GP), and an Uplink Pilot Time Slot (UpPTS). Subframe 6 may include only the DwPTS, or all three special fields, or a downlink subframe depending on the uplink-downlink configuration.

Table 1 lists seven uplink-downlink configurations supported by LTE for TDD. Each uplink-downlink configuration indicates whether each subframe is a downlink subframe (denoted as “D” in Table 1), or an uplink subframe (denoted as “U” in Table 1), or a special subframe (denoted as “S” in Table 1).

TABLE 1
Uplink-Downlink Configurations for TDD in LTE

| Uplink- | | | | | | | | | | |
|---|---|---|---|---|---|---|---|---|---|---|
| Downlink | Subframe Number n | | | | | | | | | |
| Configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

On the downlink in LTE, an eNB may transmit a primary synchronization signal (PSS) and a secondary synchronization signal (SSS) for each cell supported by the eNB. For FDD, the PSS and SSS may be sent in symbol periods 6 and 5, respectively, in subframes 0 and 5 of each radio frame with the normal cyclic prefix, as shown in FIG. 2A. For TDD, the PSS may be sent in the third symbol period of subframes 1 and 6 and the SSS may be sent in the last symbol period of slots 1 and 11 of each radio frame. The PSS and SSS may be generated based on a cell identity (ID) and may be transmitted in the center 1.08 megahertz (MHz) of a channel bandwidth. The PSS and SSS may be used by the UEs for cell search and acquisition. The eNB may transmit a Physical Broadcast Channel (PBCH) in symbol periods 0 to 3 in slot 1 of subframe 0 in certain radio frames, as shown in FIG. 2A. The PBCH may carry some system information. The eNB may also transmit a cell-specific reference signal (CRS) in symbol periods 0, 4, 7 and 11 of each downlink subframe with the normal cyclic prefix, as shown in FIGS. 2A and 2B. A reference signal is a signal that is known a priori by a transmitter and a receiver and may also be referred to as pilot. A CRS is a reference signal that is specific for a cell, e.g., generated based on a cell ID. The eNB may also transmit other physical channels and signals in each subframe.

LTE utilizes orthogonal frequency division multiplexing (OFDM) on the downlink and single-carrier frequency division multiplexing (SC-FDM) on the uplink. OFDM and SC-FDM partition a frequency range into multiple (N_{FFT}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FFT}) may be dependent on the bandwidth of a frequency channel. For example, the subcarrier spacing may be 15 kilohertz (KHz), and N_{FFT} may be equal to 128, 256, 512, 1024, 1536 or 2048 for channel bandwidth of 1.4, 3, 5, 10, 15 or 20 MHz, respectively.

The time-frequency resources available for the downlink and uplink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

A number of frequency bands (or simply, bands) may be supported for communication. Table 2 lists a set of bands supported for communication in FDD mode in LTE. For each band, Table 2 lists a range of frequencies available for the uplink (UL), a range of frequencies available for the downlink (DL), and all channel bandwidths supported by the band.

TABLE 2
Frequency Bands and Channel Bandwidths Supported in FDD Mode

| | Uplink Frequency | | Downlink Frequency | | Supported |
|---|---|---|---|---|---|
| | Range (MHz) | | Range (MHz) | | Channel |
| E-UTRA | eNB Receive/ | | eNB Transmit/ | | Bandwidth |
| Band | UE Transmit | | UE Receive | | (MHz) |
| 1 | 1920-1980 | MHz | 2110-2170 | MHz | 5, 10, 15, 20 |
| 2 | 1850-1910 | MHz | 1930-1990 | MHz | 1.4, 3, 5, 10, |
| | | | | | 15, 20 |
| 3 | 1710-1785 | MHz | 1805-1880 | MHz | 1.4, 3, 5, 10, |
| | | | | | 15, 20 |
| 4 | 1710-1755 | MHz | 2110-2155 | MHz | 1.4, 3, 5, 10, |
| | | | | | 15, 20 |
| 5 | 824-849 | MHz | 869-894 | MHz | 1.4, 3, 5, 10 |
| 6 | 830-840 | MHz | 875-885 | MHz | 5, 10 |
| 7 | 2500-2570 | MHz | 2620-2690 | MHz | 5, 10, 15, 20 |
| 8 | 880-915 | MHz | 925-960 | MHz | 1.4, 3, 5, 10 |
| 9 | 1749.9-1784.9 | MHz | 1844.9-1879.9 | MHz | 5, 10, 15, 20 |
| 10 | 1710-1770 | MHz | 2110-2170 | MHz | 5, 10, 15, 20 |
| 11 | 1427.9-1452.9 | MHz | 1475.9-1500.9 | MHz | 5, 10, 15, 20 |
| 12 | 699-716 | MHz | 729-746 | MHz | 1.4, 3, 5, 10 |
| 13 | 777-787 | MHz | 746-756 | MHz | 1.4, 3, 5, 10 |
| 14 | 788-798 | MHz | 758-768 | MHz | 1.4, 3, 5, 10 |
| 17 | 704-716 | MHz | 734-746 | MHz | Not Defined |

Table 3 lists a set of bands supported for communication in TDD mode in LTE. For each band, Table 3 lists a range of frequencies available for both the uplink and downlink and all channel bandwidths supported by the band.

TABLE 3
Frequency Bands and Channel Bandwidths Supported in TDD Mode

| | Uplink Frequency & | Supported |
|---|---|---|
| E-UTRA | Downlink Frequency | Channel bandwidth |
| Band | Range (MHz) | (MHz) |
| 33 | 1900-1920 MHz | 5, 10, 15, 20 |
| 34 | 2010-2025 MHz | 5, 10, 15 |
| 35 | 1850-1910 MHz | 1.4, 3, 5, 10, 15, 20 |
| 36 | 1930-1990 MHz | 1.4, 3, 5, 10, 15, 20 |
| 37 | 1910-1930 MHz | 5, 10, 15, 20 |
| 38 | 2570-2620 MHz | 5, 10, 15, 20 |
| 39 | 1880-1920 MHz | 5, 10, 15, 20 |
| 40 | 2300-2400 MHz | 5, 10, 15, 20 |

Tables 2 and 3 list a set of bands supported in LTE Release 10 and specified in a document 3GPP 36.101. Different and/or additional bands may also be supported by wireless systems. The availability and usage of bands for wireless communication may be dependent on frequency allocation policies of different countries and may vary from country to country. Within a given band, the actual frequency used for wireless communication may vary from one service provider to another.

Tables 2 and 3 also list a set of channel bandwidths supported for each band in LTE Release 10 and specified in 3GPP 36.101. Different and/or additional channel bandwidths may also be supported in each band. For example, service providers may choose to deploy channel bandwidths different from the ones listed in Tables 2 and 3.

A number of frequency channels may be supported in each band. Each frequency channel may be associated with a specific channel number (N_{DL}) and a specific center frequency (F_{DL}). A frequency channel may also be associated with a particular channel bandwidth, which may be variable and configured by a service provider. A frequency channel may also be referred to as a carrier, a frequency, etc. The center frequency of a frequency channel may also be referred to as a carrier frequency.

The channel raster for all bands may be set at 100 KHz, e.g., in LTE and other radio technologies. Each band may then be associated with a set of raster frequencies that are separated by 100 KHz, with each raster frequency being an integer multiple of 100 KHz. The center frequency of each frequency channel in each band would fall on one of the raster frequencies in the band. The center frequency of each frequency channel in a band may be related to the channel number of the frequency channel, as follows:

F_{DL}=F_{DL}_{_{—}}_{low}+0.1*(N_{DL}−N_{Offs-DL}), Eq (1)

where F_{DL}_{_{—}}_{low} is the lowest frequency for the band, and

N_{Offs-DL} is the lowest channel number for the band.

Table 4 lists the lowest frequency (F_{DL}_{_{—}}_{low}), the lowest channel number (N_{Offs-DL}), and a range of channel numbers for each band supported LTE Release 10 and specified in 3GPP 36.101.

TABLE 4
Channel Numbering for Downlink

| E-UTRA | Lowest Frequency, | Lowest Channel | Range of Channel |
|---|---|---|---|
| Band | F_{DL}_{_{—}}_{low} | Number, N_{Offs-DL} | Numbers, N_{DL} |
| 1 | 2110 MHz | 0 | 0-599 |
| 2 | 1930 MHz | 600 | 600-1199 |
| 3 | 1805 MHz | 1200 | 1200-1949 |
| 4 | 2110 MHz | 1950 | 1950-2399 |
| 5 | 869 MHz | 2400 | 2400-2649 |
| 6 | 875 MHz | 2650 | 2650-2749 |
| 7 | 2620 MHz | 2750 | 2750-3449 |
| 8 | 925 MHz | 3450 | 3450-3799 |
| 9 | 1844.9 MHz | 3800 | 3800-4149 |
| 10 | 2110 MHz | 4150 | 4150-4749 |
| 11 | 1475.9 MHz | 4750 | 4750-4999 |
| 12 | 729 MHz | 5000 | 5000-5179 |
| 13 | 746 MHz | 5180 | 5180-5279 |
| 14 | 758 MHz | 5280 | 5280-5379 |
| 17 | 734 MHz | 5730 | 5730-5849 |
| 33 | 1900 MHz | 26000 | 26000-26199 |
| 34 | 2010 MHz | 26200 | 26200-26349 |
| 35 | 1850 MHz | 26350 | 26350-26949 |
| 36 | 1930 MHz | 26950 | 26950-27549 |
| 37 | 1910 MHz | 27550 | 27550-27749 |
| 38 | 2570 MHz | 27750 | 27750-28249 |
| 39 | 1880 MHz | 28250 | 28250-28649 |
| 40 | 2300 MHz | 28650 | 28650-29649 |

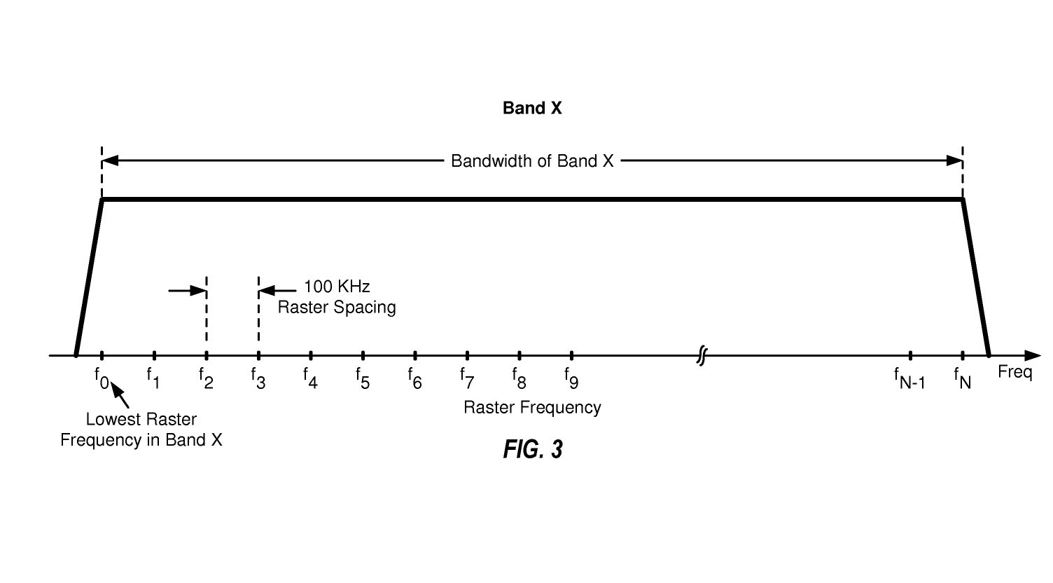

FIG. 3 shows raster frequencies in a given Band X, which may be any one of the bands supported by LTE and listed in Table 4. Band X may have a bandwidth of BW MHz and may cover N+1 raster frequencies f₀ to f_{N}, where BW may be any value and N=BW/0.1. The raster frequencies are spaced apart by 100 KHz, and the lowest raster frequency f₀ is dependent on the lowest frequency in Band X, e.g., as shown in Table 4.

A given UE may perform a system search to look for a suitable wireless system on which to receive service. For the system search, the UE may first perform a frequency scan to identify candidate frequency channels on which wireless systems might be present. The UE may then attempt acquisition of each candidate frequency channel to determine whether a wireless system is operating on the frequency channel.

For the frequency scan, the UE may evaluate frequency channels centered at different raster frequencies in each band of interest (e.g., each band supported by the UE) in order to detect a wireless system from which the UE can receive service. The UE may need to evaluate many frequency channels for the frequency scan, which may greatly delay acquisition and system search.

In one aspect of the present disclosure, the UE may store pertinent information regarding wireless systems and/or frequency channels that have been successfully acquired by the UE in the past. The pertinent information for each previously acquired wireless system or frequency channel may include one or more of the following:
Band in which the wireless system operates or the frequency channel belongs,
Center frequency of the wireless system or frequency channel,
Channel bandwidth of the wireless system or frequency channel,
Duplexing mode (e.g., FDD or TDD) of the wireless system or frequency channel,
Uplink-downlink configuration of the wireless system or frequency channel if TDD,
Received power of the wireless system or frequency channel,
Last time the UE was camped on the frequency channel,
Location or GPS coordinates of the UE at the time it camped on the frequency channel, and/or
Other information.

Received power is related to received energy by a factor of time, or Rx power=Rx energy/time. The terms “power” and “energy” may be used interchangeably, e.g., when measurements are made over a fixed/known time interval. The duplexing mode of a frequency channel may be stored since received power may be measured in different manners for FDD and TDD, as described below.

The pertinent information regarding previously acquired systems and/or frequency channels may also be referred to as prior acquisition information. The UE can more quickly perform a frequency scan by using the prior acquisition information, which may greatly expedite initial acquisition.

The UE may be provided with a UMTS Subscriber Identity Module (USIM), which may store various information to support operation and communication by the UE. The USIM may store a list of preferred Public Land Mobile Networks (PLMNs) from which the UE can receive service. This preferred PLMN list may be provisioned by a service provider with which a user has a service subscription. A PLMN may be uniquely identified by a PLMN Identification (ID), which may include a 3-bit Mobile Country Code (MCC) and a 3-bit Mobile Network Code (MNC). The preferred PLMN list typically does not include information on specific bands and channel numbers on which service may be provided.

In one design, the UE may maintain a list of previously acquired systems, which may include the center/carrier frequencies, channel bandwidths, duplexing modes, and/or other information for previously acquired systems. The list of previously acquired systems may include frequency channels previously acquired by the UE. The prior acquisition information may comprise the list of previously acquired systems. The UE may update this list whenever the UE successfully acquires service at different locations (e.g., in different countries) and/or from different service providers. The UE can more quickly perform a frequency scan based on the list of previously acquired systems. Such a frequency scan may be referred to as a “partial” frequency scan, a “list” frequency scan, etc.

The UE may not have any information on previously acquired systems, e.g., when the UE is powered on for the first time. Furthermore, the UE may have information on previously acquired systems, but the information may be deemed to be stale or unreliable for whatever reason. In either case, the UE may perform a frequency scan without any prior acquisition information. Such a frequency scan may be referred to as a “full” frequency scan and may be efficiently performed as described below.

The UE may gather prior acquisition information based on the results of a full frequency scan. For subsequent acquisition attempts, the UE may use the prior acquisition information obtained from prior successful acquisitions in an intelligent manner, e.g., to prioritize frequency scans of certain bands and/or certain portions of each band of interest. This may significantly reduce the amount of time it takes the UE to successful acquire a wireless system. In general, the UE should be able to acquire a correct frequency channel in the least amount of time possible. This may help to reduce outages as well as battery power consumption.

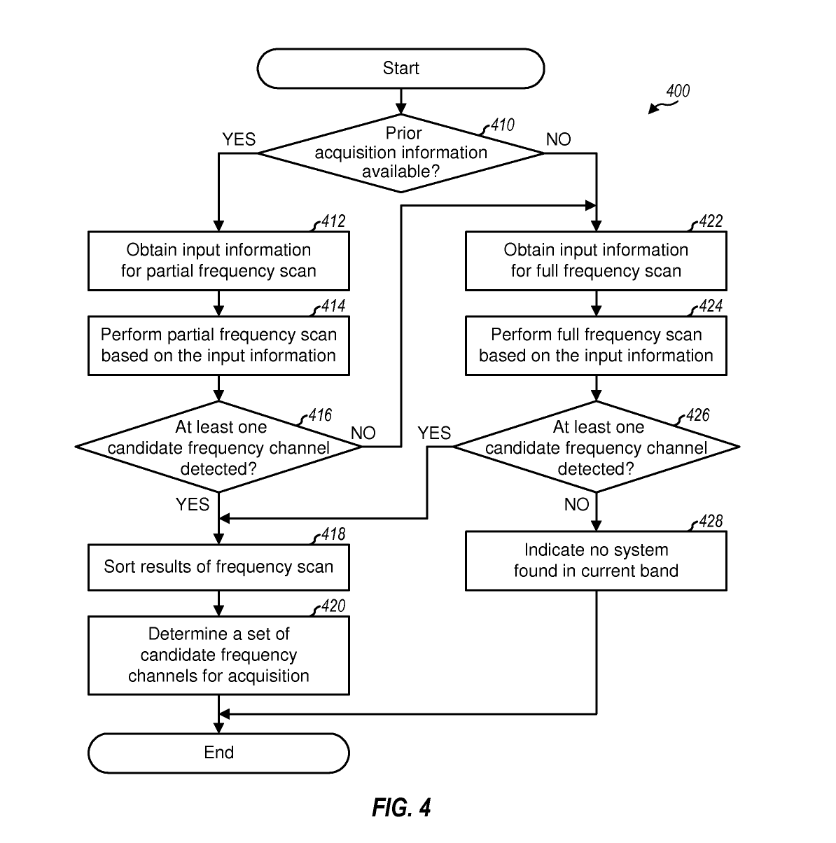

FIG. 4 shows a design of a process 400 for performing one or more frequency scans by a UE. Process 400 may be performed when the UE is powered on or when the UE desires to acquire service. The UE may initially determine whether pertinent information regarding previously acquired systems (or prior acquisition information) is available (block 412). If the answer is ‘Yes’ for block 410, then the UE may obtain input information/parameters for a partial frequency scan (block 412). Such input information may be obtained from the prior acquisition information and may include a list of frequency channels to scan, a channel bandwidth and a duplexing mode of each frequency channel, etc. The UE may perform a partial frequency scan based on the input information, as described in more detail below (block 414).

After performing the partial frequency scan in block 414, the UE may determine whether at least one candidate frequency channel was detected by the partial frequency scan (block 416). A candidate frequency channel may be a frequency channel for which the received power at the UE exceeds a detection threshold. If the answer is ‘No’ for block 416, then the UE may transition to block 422 to perform a full frequency scan. Otherwise, if at least one candidate frequency channel was detected by the partial frequency scan and the answer is ‘Yes’ for block 416, then the UE may sort the results of the partial frequency scan, e.g., based on the received powers of all frequency channels (block 418). The UE may determine a set of candidate frequency channels for acquisition based on the sorted scan results (block 420). For example, the set may include up to N_{cand} strongest frequency channels with received powers exceeding the detection threshold, where N_{cand} may be any suitable value.

If the answer is ‘No’ for block 410 or 416, then the UE may obtain input information/parameters for a full frequency scan (block 422). Such input information may include one or more specific bands to scan, a list of allowed channel bandwidths for each band, a duplexing mode for each band, etc. The UE may then perform a full frequency scan based on the input information, as described in more detail below (block 424). After performing the full frequency scan in block 424, the UE may determine whether at least one candidate frequency channel was detected by the full frequency scan (block 426). If the answer is ‘No’ for block 426, then the UE may indicate no system was found in the current band (block 428). Otherwise, if at least one candidate frequency channel was detected by the full frequency scan and the answer is ‘Yes’ for block 426, then the UE may transition to block 418 to sort the results of the full frequency scan.

If at least one candidate frequency was detected by the partial or full frequency scan, then the UE may perform acquisition based on the set of candidate frequency channels. For example, the UE may perform acquisition for one candidate frequency channel at a time, starting with the candidate frequency channel having the highest received power.

The UE may measure the received power of a given frequency channel Y (or simply, frequency Y) for a frequency scan. The UE may not know whether a wireless system operates on frequency Y and may also have no timing information for frequency Y. For FDD, only downlink signals may be transmitted on frequency Y. Hence, the UE can measure the received power of frequency Y over any 1 ms interval and can capture at least four OFDM symbols containing CRS, as shown in FIG. 2A. The UE can thus reliably measure the received power of frequency Y based on 1 ms of OFDM symbols for FDD.

For TDD, downlink signals may be transmitted on frequency Y in some time intervals, and uplink signals may be transmitted on frequency Y in other time intervals. The uplink signals may be transmitted by other UEs anywhere within the channel bandwidth. Since the UE does not have timing information for frequency Y, the UE would not know whether it has measured the received power of downlink signals or uplink signals based on measurement over a 1 ms interval. If the UE measures received power over a 1 ms interval that happens to cover an uplink subframe, then the UE would obtain received power for uplink signals instead of downlink signals on frequency Y, and the received power of frequency Y would be inaccurate. Furthermore, the uplink signals may be transmitted by other UEs in a wireless system operating on another frequency Z but may happen to be centered on frequency Y, which may then result in a false alarm for carrier frequency hypothesis. A false alarm may occur, for example, in a scenario where the downlink is lightly loaded and a strong nearby UE happens to transmit on the uplink, thereby introducing a bias in the carrier frequency hypothesis.

Measurement and detection errors in TDD may be mitigated by using known information for the uplink-downlink configuration of frequency Y, if this information is available at the UE. This information may be obtained from prior successful acquisition of frequency Y by the UE. The UE may measure received power over a longer interval and/or make more received power measurements for frequency Y if the uplink-downlink configuration includes more uplink subframes than downlink subframes, and vice versa. The UE may also measure the received power of frequency Y to take into account the fact that the uplink-downlink configuration of frequency Y may be a semi-static parameter that may change over time. For example, more traffic load on the uplink may prompt a wireless system to use an uplink-downlink configuration with more uplink subframes for frequency Y, and the load pattern may change based on time of the day.

In one design, the UE may measure the received power of frequency Y over a measurement interval that is defined to include at least one downlink subframe. As shown in Table 1, there is at least one downlink subframe in every 5 ms because subframes 0 and 5 are downlink subframes for all uplink-downlink configurations. Hence, the UE may measure the received power of frequency Y over a measurement interval of at least 5 ms in order to ensure that the measurement will capture downlink signals in at least downlink subframe.

In general, measurement of received power over more downlink subframes may reduce measurement and detection errors in TDD. A measurement interval of 5 ms may provide a good tradeoff between measurement and detection errors in TDD and measurement delay for a frequency scan. Detection errors from the frequency scan stage may be identified/caught in the next stage of initial acquisition, which may be detection of the PSS and SSS.

The UE may be equipped with one or more receive antennas and may have a low noise amplifier (LNA) coupled to each receive antenna. Each LNA may amplify a received signal from an associated antenna and provide an amplified signal. The amplified signal may be further processed (e.g., filtered, downconverted, amplified, etc.) and digitized to obtain input samples. In one design, the UE may set the gain of each LNA to an appropriate value prior to making power measurements in order to avoid saturation due to the LNA gain being too high or excessive quantization noise due to the LNA gain being too low. The UE may set the gain of each LNA independently by measuring the total in-band power (e.g., in hardware) and processing the total in-band power measurements (e.g., in firmware) to obtain the proper LNA gain.

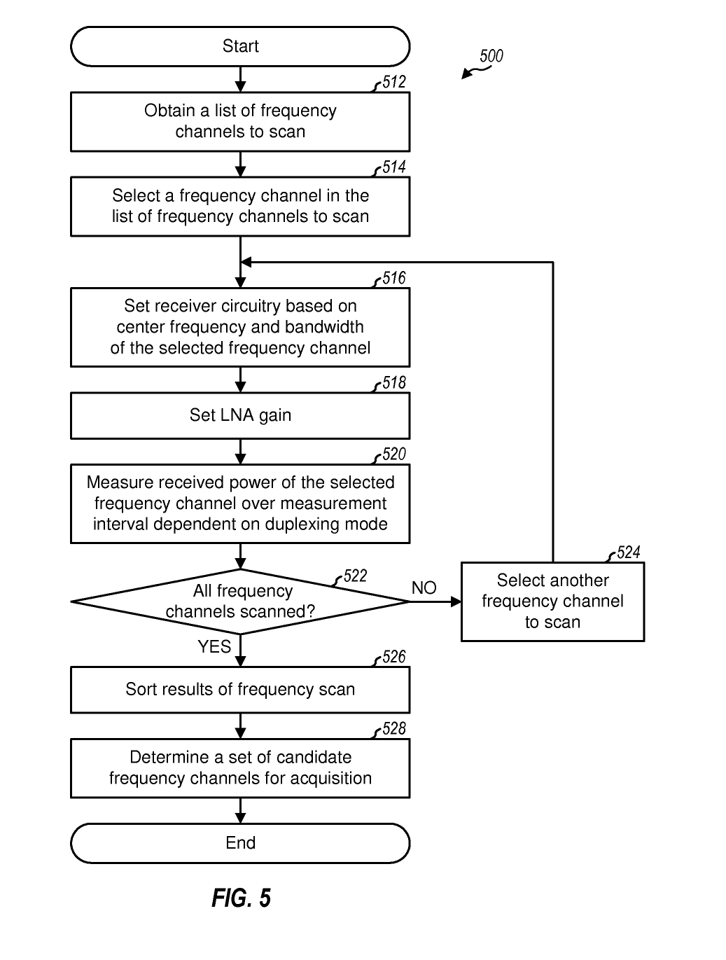

FIG. 5 shows a design of a process 500 for performing a partial frequency scan by a UE. Process 500 may be used for block 414 in FIG. 4. The UE may initially obtain a list of frequency channels to scan, which may be referred to as a scan list (block 512). Each frequency channel in the scan list may be a frequency channel previously acquired by the UE. The scan list may include a channel bandwidth, a duplexing mode, and/or other information for each frequency channel in the scan list. The size of the scan list may be limited to N_{ch} frequency channels, where N_{ch} may be any suitable value. In this case, previously acquired frequency channels may be prioritized based on PLMN, quality-of-service (QoS), time since last acquisition, received power, etc. N_{ch} frequency channels with the highest priorities may then be included in the scan list.

The UE may select a frequency channel in the scan list to scan (block 514). The UE may set receiver circuitry based on the center frequency and the bandwidth of the selected frequency channel (block 516). For example, the UE may set one or more filters in the receiver circuitry based on the bandwidth of the selected frequency channel and may set the frequency of local oscillator (LO) signals used for downconversion based on the center frequency of the selected frequency channel.

The UE may set the gain of each LNA used for power measurement (block 518). In one design, the UE may initially set the gain of each LNA to a mid value, obtain input samples based on the initial LNA gain over an update interval of T_{update} ms, compute the received power of the input samples in each symbol period within the update interval, and determine the maximum received power across the update interval. The UE may then set the gain of each LNA based on the maximum received power for that LNA. The update interval may be dependent on the duplexing mode of the selected frequency channel and may be set to 1 ms for FDD or 5 ms for TDD.

The UE may then measure the received power of the selected frequency channel (block 520). In one design, the UE may obtain input samples over a measurement interval of Tₘₑₐₛ ms, compute the received power of the input samples in each symbol period within the measurement interval, and determine the maximum or the average received power over the measurement interval. The measurement interval may be dependent on the duplexing mode of the selected frequency channel and may be set to 1 ms for FDD or 5 ms for TDD. If the UE is equipped with multiple receive antennas, then the UE may independently measure the received power for each receive antenna and may combine (e.g., linearly average) the received powers for all receive antennas to obtain a final received power.

A determination may then be made whether all frequency channels in the scan list have been scanned (block 522). If the answer is ‘No’, then the UE may select another frequency channel in the scan list to scan (block 524). The UE may then return to block 516 to measure the received power of the newly selected frequency channel. Otherwise, if all frequency channels in the scan list have been scanned and the answer is ‘Yes’ for block 522, then the UE may sort the scan results, e.g., based on received powers of all frequency channels in the scan list (block 526). The UE may determine a set of candidate frequency channels for acquisition based on the sorted scan results (block 528).

FIG. 5 shows a design in which the UE measures the received powers of all frequency channels in the scan list, one frequency channel at a time. In another design, the UE may terminate the partial frequency scan when the received power of any frequency channel is greater than a high threshold. The UE may then attempt acquisition on this frequency channel, which may reduce the amount of time for initial acquisition.

In one design, the UE may generate a list of raster frequencies for each scanned frequency channel, which may be referred to as a raster list. The raster list for a scanned frequency channel may include all raster frequencies that (i) fall within the bandwidth of the scanned frequency channel and (ii) have received power exceeding a noise threshold. The raster lists for all scanned frequency channels may be used to remove frequencies from a full frequency scan, as described below.

FIG. 6 shows a design of a process 600 for performing a full frequency scan by a UE. Process 600 may be used for block 424 in FIG. 4. The UE may initially obtain a list of bands to scan, which may be referred to as a band list (block 612). Each band in the band list may be associated with a range of frequencies covered by the band, a set of possible channel bandwidths, a duplexing mode, and/or other information, e.g., as shown in Tables 2 to 4.

The UE may select a band in the band list to scan (block 614). If the selected band covers more than 20 MHz, then the UE may partition the selected band into multiple segments covering different portions of the selected band. The number of segments, the bandwidth of each segment, and the center frequency of each segment may be determined for the selected band as described below. If the selected band covers 20 MHz or less, then there may be only one segment for the selected band. In any case, the UE may select a segment of the selected band to measure (block 616). The UE may set receiver circuitry based on the center frequency and the bandwidth of the selected segment (block 618). For example, the UE may set one or more filters in the receiver circuitry based on the bandwidth of the selected segment and may set the frequency of LO signals used for downconversion based on the center frequency of the selected segment.

The UE may set the gain of each LNA used for power measurement, e.g., as described above for block 518 in FIG. 5 (block 620). The gain of each LNA may be set based on received power measured over an update interval, which may be dependent on the duplexing mode of the selected band. The UE may then measure the received powers of different raster frequencies within the selected segment, as described below (block 622). The UE may save the received powers of different raster frequencies in the selected segment for subsequent processing.

A determination may then be made whether all segments of the selected band have been measured (block 624). If the answer is ‘No’, then the UE may select another segment of the selected band to measure (block 626). The UE may then return to block 618 to measure received power of the newly selected segment. Otherwise, if all segments of the selected band have been measured and the answer is ‘Yes’ for block 624, then the UE may measure the received powers of different possible frequency channels and bandwidths within the selected band, as described below (block 628).

A determination may then be made whether all bands in the band list have been scanned (block 630). If the answer is ‘No’, then the UE may select another band in the band list to scan (block 632). The UE may then return to block 616 to make power measurements for the newly selected band. Otherwise, if all bands in the band list have been scanned and the answer is ‘Yes’ for block 630, then the UE may sort the results of the frequency scan as described below (block 634). The UE may determine a set of candidate frequency channels for acquisition based on the sorted scan results (block 636).

The UE may perform a frequency scan for a given band in various manners. The band may be associated with a set of possible channel bandwidths, e.g., as shown in Tables 2 and 3. In one design, the band may be partitioned into segments if it covers a frequency range that is larger than the largest possible channel bandwidth for the band. Each segment may have a bandwidth that is equal to or smaller than the largest possible channel bandwidth for the band. The UE may then perform a frequency scan for each segment and may set the receiver circuitry in similar manner as if receiving a downlink signal in the segment.

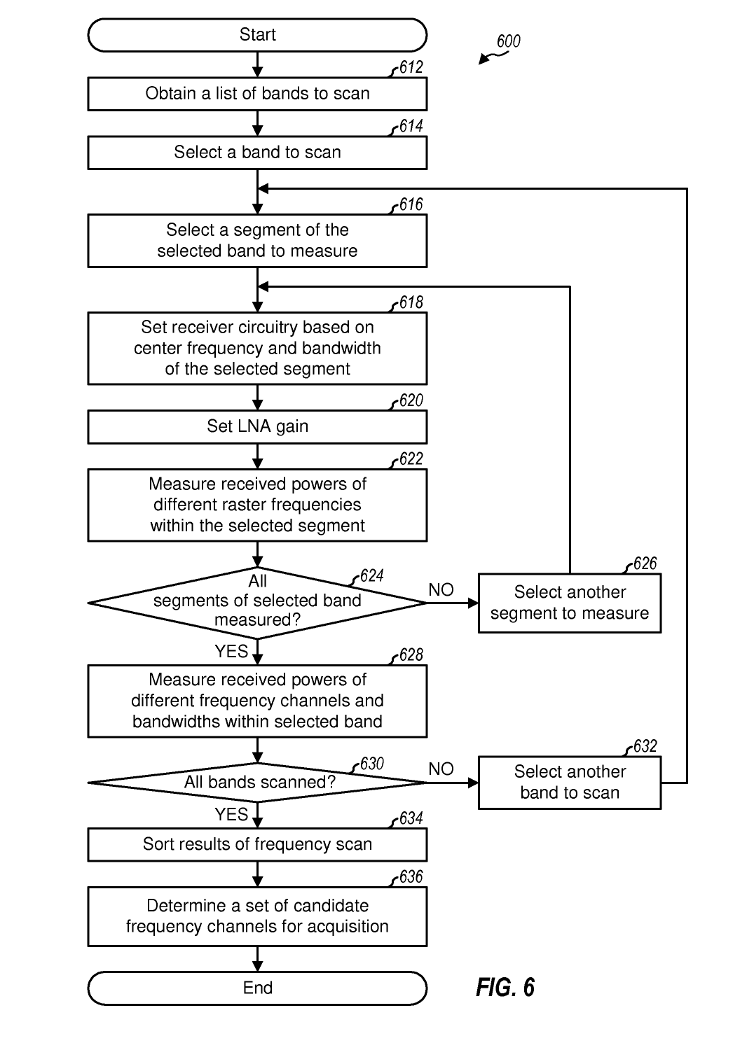

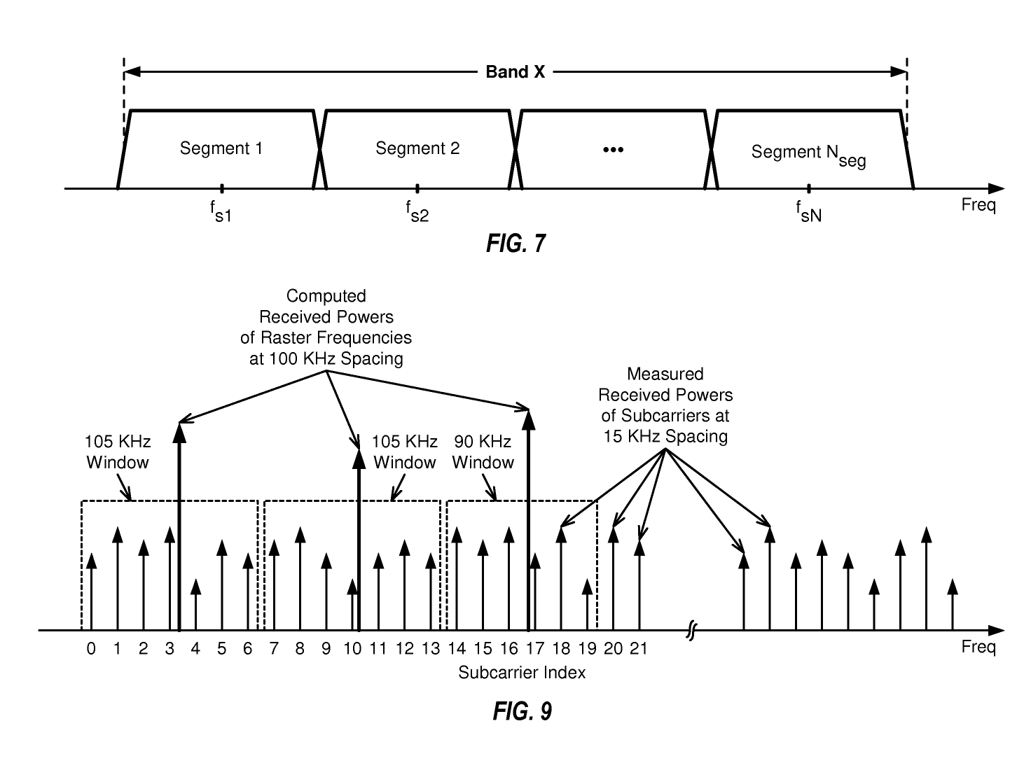

FIG. 7 shows partitioning of a given Band X into multiple (N_{seg}) segments. Each segment may have a bandwidth of BW_{seg}, which may be selected as follows:

BW_{seg}=Min(BW_{band},BWₘₐₓ_{_{—}}_{sys}), Eq (2)

where BWₘₐₓ_{_{—}}_{sys} is the largest possible channel bandwidth in Band X, and

BW_{band} is the bandwidth of Band X.

In the design shown in equation (2), the segment bandwidth is equal to the smaller of (i) the bandwidth of Band X and (ii) the largest possible channel bandwidth in Band X. In general, the segments may have the same bandwidth or different bandwidths. The number of segments in Band X may be determined as follows:

$${N}_{seg} = ⌈ \frac{{BW}_{band}}{{BW}_{seg}} ⌉ , \qquad Eq ( 3 )$$

where ┌ ┐ denotes a ceiling operator.

The N_{seg} segments may be associated with different center frequencies fₛ₁ to f_{sN}, which may be defined as follows:

$$\begin{matrix}{f}_{s 1} = {f}_{low , X} + \frac{{BW}_{seg}}{2} , \\ and & Eq ( 4 ) \\ {f}_{s ( i + 1 )} = {f}_{si} + {BW}_{seg} , \\ for i = 1 , … , {N}_{seg} - 1 , & Eq ( 5 )\end{matrix}$$

where f_{low,x} is the lowest frequency of Band X.

In the design shown in equations (4) and (5), the center frequencies of the segments are separated by the bandwidth of one segment. The center frequencies of the N_{seg} segments may also be defined in other manners and may or may not be equally spaced apart.

Table 5 lists the lowest frequency and the bandwidth of each band. Table 5 also lists, for each band, the number of segments and the bandwidth of each segment in the band. The bandwidth of a band may not be an integer multiple of the bandwidth of a segment in the band. In this case, some segments may overlap, or segments of different bandwidths may be used. For example, Band 3 has a bandwidth of 75 MHz and may be partitioned into four 20 MHz segments with center frequencies of 1815, 1835, 1855 and 1870 MHz, with the last two segments overlapping. Alternatively, Band 3 may be partitioned into four non-overlapping segments with bandwidths of 20, 20, 20 and 15 MHz and center frequencies of 1815, 1835, 1855 and 1872.5 MHz.

TABLE 5
Partitioning of a Band into Segments

| | Lowest | | Bandwidth | Number of |
|---|---|---|---|---|
| E-UTRA | Frequency | Bandwidth of | of Segment, | Segments, |
| Band | of Band, f_{low,X} | Band, BW_{band} | BW_{seg} | N_{seg} |
| 1 | 2110 MHz | 60 MHz | 20 MHz | 3 |
| 2 | 1930 MHz | 60 MHz | 20 MHz | 3 |
| 3 | 1805 MHz | 75 MHz | 20 MHz | 4 |
| 4 | 2110 MHz | 45 MHz | 20 MHz | 3 |
| 5 | 869 MHz | 25 MHz | 20 MHz | 2 |
| 6 | 875 MHz | 10 MHz | 10 MHz | 1 |
| 7 | 2620 MHz | 70 MHz | 20 MHz | 4 |
| 8 | 925 MHz | 35 MHz | 20 MHz | 2 |
| 9 | 1844.9 MHz | 35 MHz | 20 MHz | 2 |
| 10 | 2110 MHz | 60 MHz | 20 MHz | 3 |
| 11 | 1475.9 MHz | 25 MHz | 20 MHz | 2 |
| 12 | 729 MHz | 18 MHz | 10 MHz | 2 |
| 13 | 746 MHz | 10 MHz | 10 MHz | 1 |
| 14 | 758 MHz | 10 MHz | 10 MHz | 1 |
| 17 | 734 MHz | 12 MHz | 10 MHz | 2 |
| 33 | 1900 MHz | 20 MHz | 20 MHz | 1 |
| 34 | 2010 MHz | 15 MHz | 10 MHz | 2 |
| 35 | 1850 MHz | 60 MHz | 20 MHz | 3 |
| 36 | 1930 MHz | 60 MHz | 20 MHz | 3 |
| 37 | 1910 MHz | 20 MHz | 20 MHz | 1 |
| 38 | 2570 MHz | 50 MHz | 20 MHz | 3 |
| 39 | 1880 MHz | 40 MHz | 20 MHz | 2 |
| 40 | 2300 MHz | 100 MHz | 20 MHz | 5 |

The UE may perform a full frequency scan for a given Band X using the same receiver circuitry and digital circuitry used to process a received signal for communication. The receiver circuitry and digital circuitry may be able to process the received signal for a bandwidth of up to 20 MHz, which may be the largest channel bandwidth supported by LTE. If Band X covers more than 20 MHz, then the UE may partition Band X into multiple segments and may process each segment in a piecemeal manner.

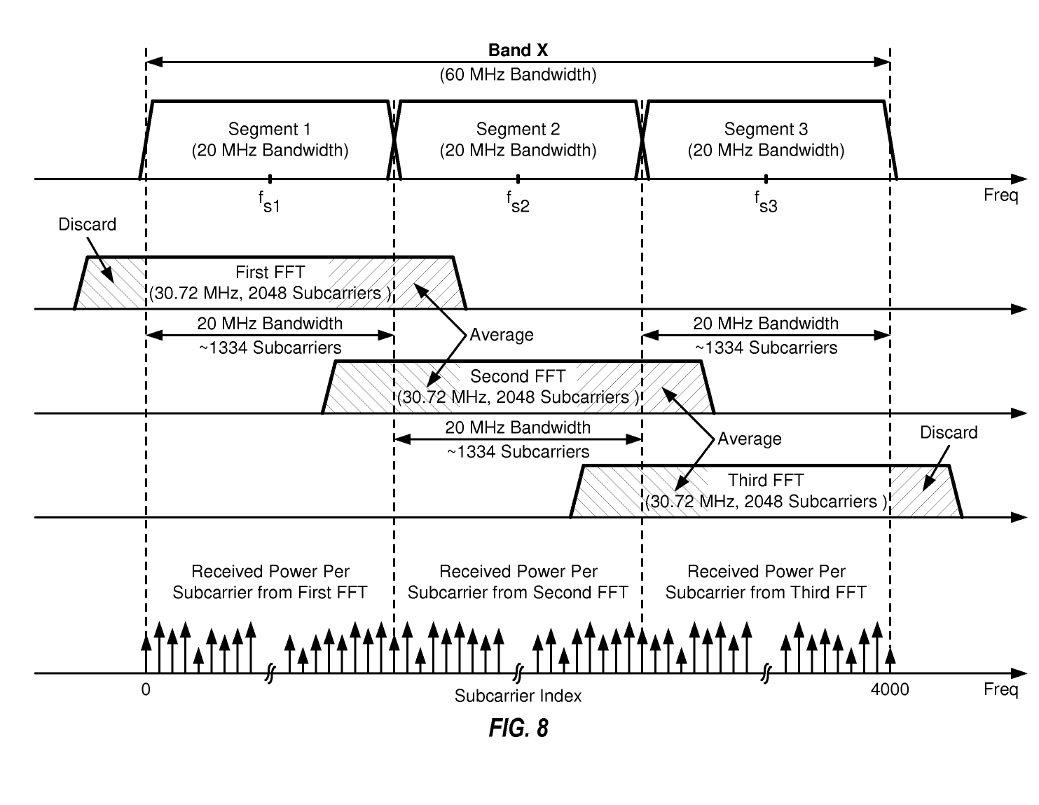

FIG. 8 shows an example of performing a full frequency scan for a given Band X with a bandwidth of 60 MHz (e.g., Band 1 in Table 5). Band X may be partitioned into three segments 1, 2 and 3, with each segment having a bandwidth of 20 MHz. Segments 1, 2 and 3 have center frequencies of fₛ₁, fₛ₂ and fₛ₃, respectively.

To scan segment 1 having a 20 MHz bandwidth, the UE may condition (e.g., amplify and filter) a received signal and downconvert the conditioned signal with LO signals at frequency fₛ₁ to obtain a baseband signal for segment 1. The UE may digitize the baseband signal at a sample rate of 30.72 MHz to obtain input samples. The UE may then transform a block of 2048 input samples to the frequency domain with a 2048-point fast Fourier transform (FFT) to obtain 2048 received symbols for 2048 subcarriers. The 2048 subcarriers cover a frequency range of 30.720 MHz and are spaced apart by 15 KHz. The UE may compute the power of each received symbol.

To scan a segment having a 10 MHz bandwidth, the UE may digitize a baseband signal at a sample rate 15.36 MHz. The UE may then perform a 1024-point FFT on a block of 1024 input samples to obtain 1024 received symbols for 1024 subcarriers spaced apart by 15 KHz. The UE may compute the power of each received symbol.

The UE may repeat the power computation for each of a number of sample blocks. For example, the UE may repeat the power computation for each of 15 sample blocks obtained over a measurement interval of 1 ms, with each sample block including 2048 input samples. The UE may obtain a set of received powers for a set of subcarriers for each sample block. The UE may accumulate or average the received powers obtained for all sample blocks, for each subcarrier, to obtain a final received power for the subcarrier. For example, the UE may accumulate or average 15 received powers from the 15 sample blocks for each subcarrier i, where index i ranges from 0 to 2047 for 20 MHz bandwidth.

The UE may repeat the same processing for each of the three segments 1, 2 and 3 in Band X. The UE may obtain 2048 received powers for 2048 subcarriers from the first set of FFTs for segment 1, obtain 2048 received powers for 2048 subcarriers from the second set of FFTs for segment 2, and obtain 2048 received powers for 2048 subcarriers from the third set of FFTs for segment 3. The UE may scale the received powers for each segment to account for the gain of the receiver circuitry for that segment. This scaling may normalize the received powers for different segments so that they can be concatenated together. The UE may place the 2048 received powers from each set of FFTs at appropriate location in frequency, as shown in FIG. 8. The UE may discard received powers from the first set of FFTs for subcarriers that are outside (to the left) of segment 1 and may also discard received powers from the third set of FFTs for subcarriers that are outside (to the right) of segment 3. The UE may average received powers from the first and second sets of FFTs for subcarriers that overlap in frequency. The UE may also average received powers from the second and third sets of FFTs for subcarriers that overlap in frequency. The UE may obtain 4001 received powers for 4001 subcarriers within the 60 MHz bandwidth of Band X. These 4001 received powers are indicative of the received power across frequency (sampled at 15 KHz spacing) in Band X at the UE.

The UE may obtain received powers of subcarriers that are spaced apart by 15 KHz, e.g., as shown in FIG. 8. However, the channel raster is 100 KHz for all bands. The UE may convert/downsample received powers for subcarriers at 15 KHz spacing into received powers for raster frequencies at 100 KHz spacing.

FIG. 9 (which is located after FIG. 7 in the drawings) shows a design of downsampling from subcarriers at 15 KHz spacing to raster frequencies at 100 KHz spacing. In this design, a UE may divide all subcarriers within Band X into blocks, with each block including 20 consecutive subcarriers at 15 KHz spacing. Each block may cover 300 KHz and may be divided into three groups—a first group of seven consecutive subcarriers, a second group of the next seven consecutive subcarriers, and a third group of six consecutive subcarriers. The UE may average the received powers of the seven subcarriers in the first group to obtain a received power for a first raster frequency, average the received powers of the seven subcarriers in the second group to obtain a received power for a second raster frequency, and average the received powers of the six subcarriers in the third group to obtain a received power for a third raster frequency. The UE may repeat the processing for every block of 20 consecutive subcarriers to obtain three received powers for three raster frequencies covered by that block.

The UE may obtain a set of received powers for all raster frequencies within Band X from the processing shown in FIG. 9. The UE may then compute a received power of each possible frequency channel within Band X.

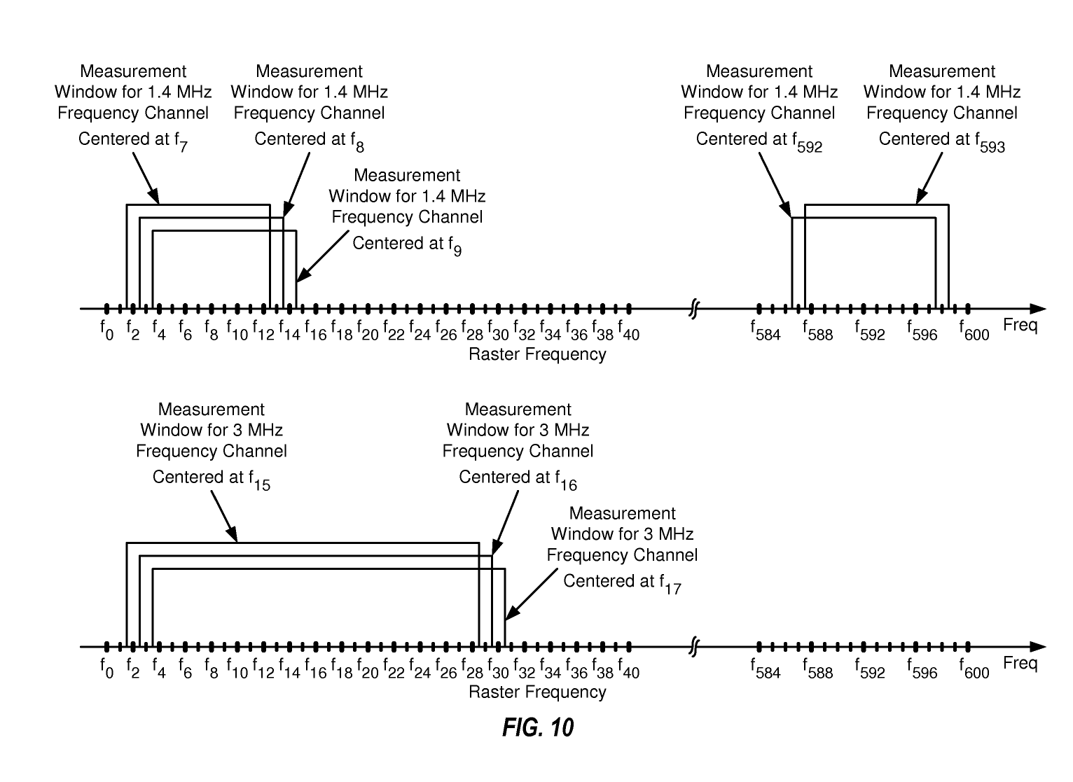

FIG. 10 shows an example of computing received powers of different possible frequency channels within Band X. In the example shown in FIG. 10, Band X covers 60 MHz and includes 601 raster frequencies f₀ to f₆₀₀. To measure frequency channels of 1.4 MHz, the UE may initially place a measurement window covering 11 raster frequencies centered at raster frequency f₇. The measurement window may cover a usable bandwidth of 1.08 MHz and may omit guard bands on both edges of the 1.4 MHz channel bandwidth. The UE may compute the average power of the 11 raster frequencies within the measurement window to obtain a received power for a 1.4 MHz frequency channel centered at frequency f₇. The UE may then slide the measurement window to the right by 100 KHz and may again compute the average power of the 11 raster frequencies within the measurement window to obtain a received power for a 1.4 MHz frequency channel centered at frequency f₈. The UE may repeat the processing until the measurement window is centered at the highest frequency f₅₉₃. The UE may compute the average power of the 11 raster frequencies within the measurement window to obtain a received power for a 1.4 MHz frequency channel centered at frequency f₅₉₃.

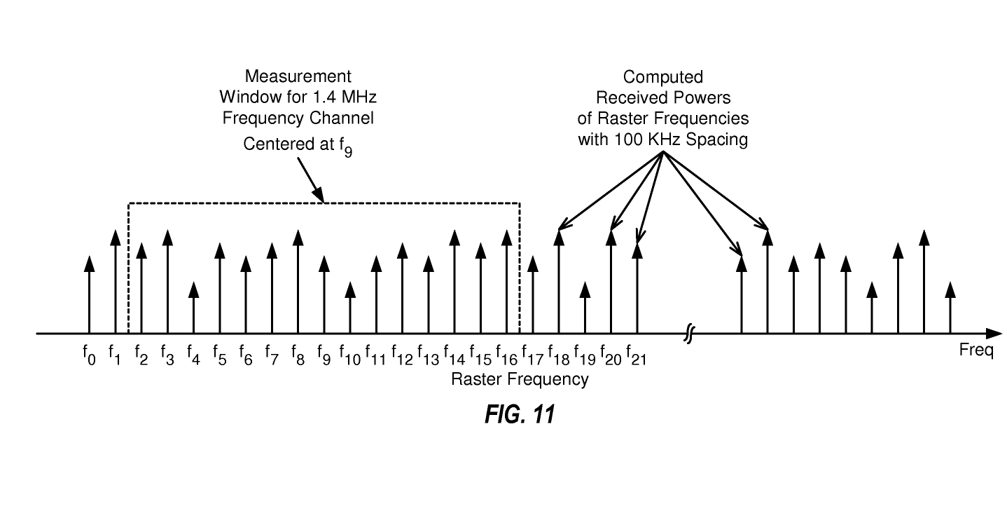

FIG. 11 shows placement of the measurement window for a 1.4 MHz frequency channel with a center frequency of f₉. The measurement window covers 5 raster frequencies on each side of the center frequency. The UE may average the 11 received powers of the 11 raster frequencies within the measurement window to obtain a received power for the 1.4 MHz frequency channel with a center frequency of f₉.

Referring back to FIG. 10, the UE may repeat the processing described above for each remaining possible channel bandwidth in Band X. To measure frequency channels of 3 MHz, the UE may initially place a measurement window covering 27 raster frequencies centered at raster frequency f₁₅. The UE may then compute the average power of the 27 raster frequencies within the measurement window to obtain a received power for a 3 MHz frequency channel centered at frequency f₁₅. The UE may then slide the measurement window to the right by 100 KHz and may repeat the power computation.

Table 6 lists the size of the measurement window for each channel bandwidth. The measurement window includes 2 N+1 raster frequencies, or N raster frequencies on each side of the center frequency.

TABLE 6
Measurement Window Size versus Channel Bandwidth

| | | | Usable | | Window |
|---|---|---|---|---|---|
| | | Usable | Bandwidth | | Size |
| | | Bandwidth | in number | | in number |
| Channel | Usable | in number of | of resource | Measurement | of raster |
| Bandwidth | Bandwidth | subcarriers | blocks | Window Size | frequencies |
| 1.4 MHz | 1.08 MHz | 72 | 6 | 1.1 MHz | 11 |
| 3 MHz | 2.7 MHz | 180 | 15 | 2.7 MHz | 27 |
| 5 MHz | 4.5 MHz | 300 | 25 | 4.5 MHz | 45 |
| 10 MHz | 9 MHz | 600 | 50 | 9.1 MHz | 91 |
| 15 MHz | 13.5 MHz | 900 | 75 | 13.5 MHz | 135 |
| 20 MHz | 18 MHz | 1200 | 100 | 18.1 MHz | 181 |

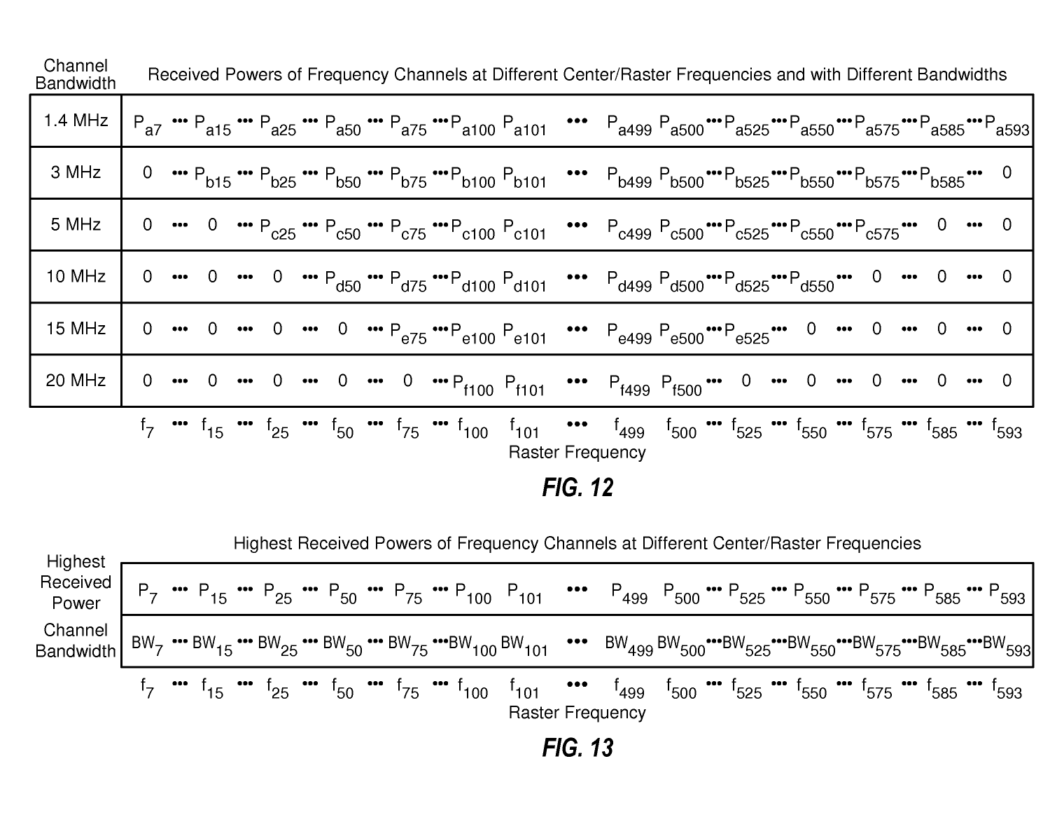

FIG. 12 shows received powers of all possible frequency channels in Band X covering 60 MHz. The UE may obtain received powers of Pₐ₇ to Pₐ₅₉₃ for 1.4 MHz frequency channels at center frequencies of f₇ to f₅₉₃, respectively. The UE may obtain received powers of P_{b15} to P_{b585} for 3 MHz frequency channels at center frequencies of f₁₅ to f₅₈₅, respectively. The UE may obtain received powers of P_{c25} to P_{c575} for 5 MHz frequency channels at center frequencies of f₂₅ to f₅₇₅, respectively. The UE may obtain received powers of P_{d50} to P_{d550} for 10 MHz frequency channels at center frequencies of f₅₀ to f₅₅₀, respectively. The UE may obtain received power of Pₑ₇₅ to P_{d525} for 15 MHz frequency channels at center frequencies of f₇₅ to f₅₂₅, respectively. The UE may obtain received powers of P_{f100} to P_{f500} for 20 MHz frequency channels at center frequencies of f₁₀₀ to f₅₀₀, respectively.

The UE may obtain a large number of received powers for all possible frequency channels of different possible bandwidths in Band X. The UE may sort these received powers to determine candidate frequency channels for acquisition.

FIG. 13 shows a design of sorting received powers for a full frequency scan. For each raster frequency, the UE may determine the highest received power among all frequency channels of different bandwidths centered at that raster frequency. The UE may store the received power Pᵢ and the bandwidth BWᵢ of the frequency channel with the highest received power at each raster frequency i.

The UE may obtain a set of received powers for a set of strongest frequency channels centered at all raster frequencies in Band X from the sorting described above. The UE may remove raster frequencies based on results of prior partial frequency scans, if any. For example, the UE may remove raster frequencies corresponding to frequency channels for which partial frequency scans were unsuccessful. The UE may then sort the received powers of the frequency channels in Band X and may select a set of candidate frequency channels with the highest received powers for acquisition. The candidate frequency channels may also be selected based on one or more criteria. For example, the received power of a candidate frequency channel may be required to be higher than a detection threshold. In any case, each candidate frequency channel may be associated with a specific center frequency and a specific channel bandwidth. The UE may attempt acquisition on the candidate frequency channels, e.g., one candidate frequency channel at a time starting with the highest priority (e.g., strongest) candidate frequency channel.

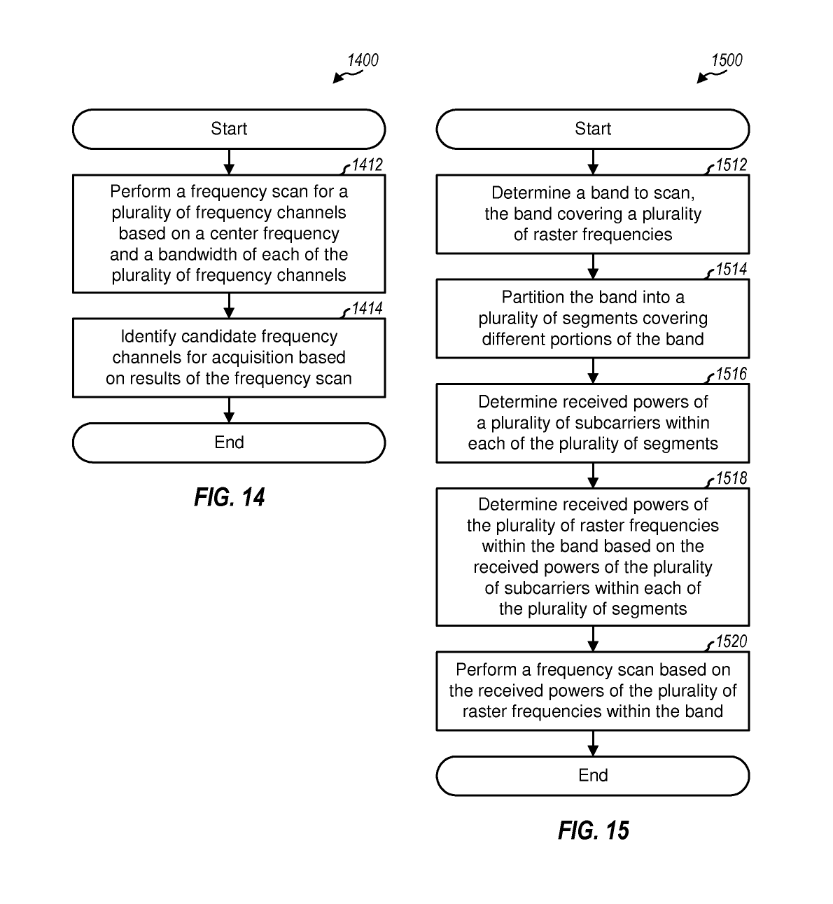

FIG. 14 shows a design of a process 1400 for performing a frequency scan. Process 1400 may be performed by a UE (as described below) or by some other entity. The UE may perform a frequency scan for a plurality of frequency channels based on a center frequency and a bandwidth of each of the plurality of frequency channels (block 1412). The UE may identify candidate frequency channels for acquisition based on the results of the frequency scan (block 1414).

For the frequency scan in block 1412, the UE may measure the received power of each frequency channel based on the center frequency and the bandwidth of that frequency channel. In one design, the UE may determine the received power of each frequency channel based on the received powers of a plurality of subcarriers within the bandwidth of the frequency channel, e.g., as shown in FIG. 11.

In one design, the bandwidth of a frequency channel may be known from prior successful acquisition of the frequency channel. The UE may then measure the received power of the frequency channel based on the known bandwidth of the frequency channel. In another design, the bandwidth of a frequency channel may be unknown. The UE may then measure the received power of the frequency channel for each of a plurality of possible bandwidths for the frequency channel.

For a full frequency scan, the UE may determine the plurality of frequency channels based on a band to scan. For a partial frequency scan, the UE may retrieve stored information for the plurality of frequency channels. The stored information may comprise the center frequency and the bandwidth of each frequency channel, which may be determined from previous acquisition of the frequency channel. The stored information may further comprise a duplexing mode of each of the plurality of frequency channels, an uplink-downlink configuration for each frequency channel associated with a TDD mode, a received power of each frequency channel obtained from prior acquisition of the frequency channel, an elapsed time since last acquisition of each frequency channel, and/or other information. The UE may measure the received power of each frequency channel over a time interval determined based on the duplexing mode of the frequency channel. The UE may measure the received power of each frequency channel associated with a TDD mode based further on an uplink-downlink configuration of the frequency channel.

The UE may prioritize the plurality of frequency channels based on at least one criterion, e.g., based on PLMN, QoS, received power, etc. The UE may perform the frequency scan based on the priority of each of the plurality of frequency channels. The UE may set a gain of an LNA based on at least one initial power measurement for at least one frequency channel. The UE may terminate the frequency scan when the received power of any frequency channel exceeds a threshold.

FIG. 15 shows a design of a process 1500 for performing a frequency scan of a band in segments. Process 1500 may be performed by a UE (as described below) or by some other entity. The UE may determine a band to scan, with the band covering a plurality of raster frequencies (block 1512). The UE may partition the band into a plurality of segments covering different portions of the band (block 1514). The band may be associated with a plurality of supported channel bandwidths. Each segment may have a bandwidth that is equal to or smaller than the largest supported channel bandwidth in the band, e.g., as shown in equation (2).

The UE may determine the received powers of a plurality of subcarriers within each of the plurality of segments (block 1516). For block 1516, the UE may obtain input samples for each segment based on the center frequency and the bandwidth of that segment. The UE may transform the input samples for each segment to the frequency domain with an FFT and may obtain received symbols for a set of subcarriers. The UE may compute the received power of each subcarrier based on the received symbol for that subcarrier. The UE may concatenate the received powers of subcarriers within all segments, e.g., as shown in FIG. 8. The UE may determine a gain of an LNA used for each segment. The UE may scale the received powers of the plurality of subcarriers within each segment based on the gain of the LNA for the segment.

The UE may determine the received powers of the plurality of raster frequencies within the band based on the received powers of the plurality of subcarriers within each of the plurality of segments (block 1518). In general, the frequency spacing of the subcarriers may or may match the frequency spacing of the raster frequencies. In one design, the plurality of raster frequencies within the band may have a first frequency spacing (e.g., 100 KHz spacing), and the plurality of subcarriers within each segment may have a second frequency spacing (e.g., 15 KHz spacing), which is different from the first frequency spacing. In one design of block 1518, the UE may determine a group of subcarriers associated with each of the plurality of raster frequencies. The UE may determine the received power of each raster frequency based on the received powers of the group of subcarriers associated with that raster frequency, e.g., as shown in FIG. 9.

The UE may perform a frequency scan based on the received powers of the plurality of raster frequencies within the band (block 1520). In one design, the UE may measure the received power of each of a plurality of frequency channels within the band based on the received powers of the plurality of raster frequencies within the band, e.g., as shown in FIGS. 10 and 11. The UE may measure the received power of each frequency channel, for each of a plurality of possible bandwidths for the frequency channel, based on the received powers of the plurality of raster frequencies within the band, e.g., as shown in FIG. 10. The UE may then determine a frequency channel and a bandwidth associated with the highest received power for each of the plurality of raster frequencies within the band, e.g., as shown in FIG. 13. The UE may identify candidate frequency channels for acquisition based on the frequency channels and bandwidths associated with the highest received powers within the band. The UE may remove frequency channels corresponding to raster frequencies for which prior acquisition was unsuccessful. The UE may then identify the candidate frequency channels based on frequency channels corresponding to the remaining raster frequencies within the band.

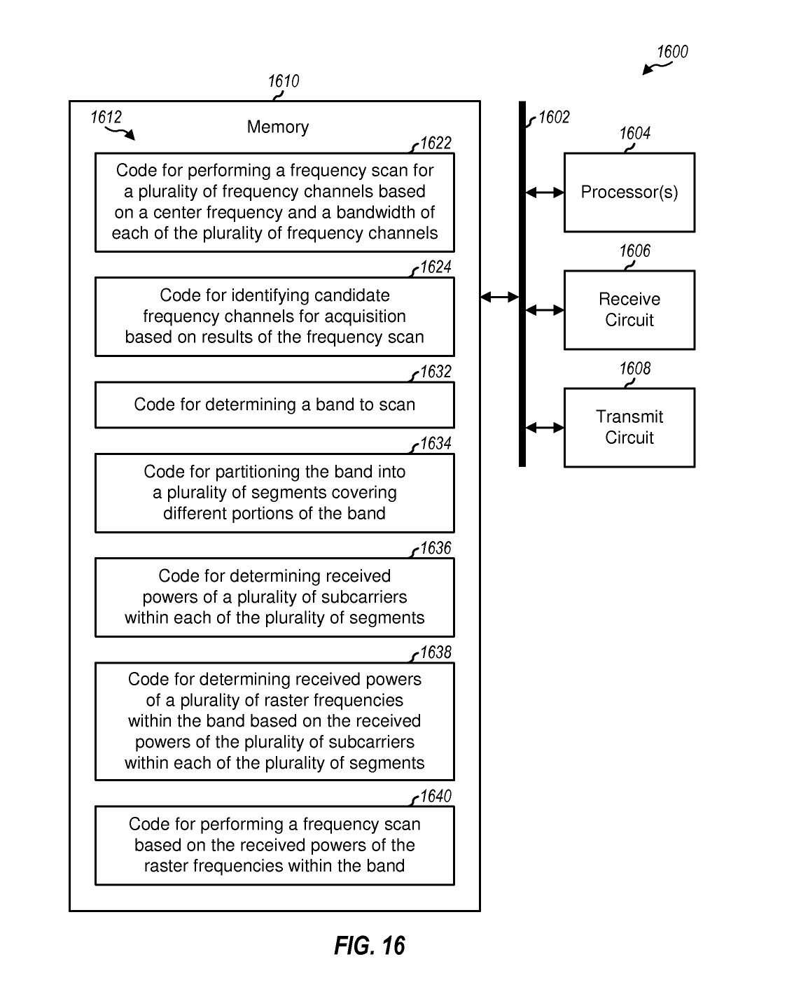

FIG. 16 shows part of a hardware implementation of an apparatus 1600, which may be able to perform process 400 in FIG. 4, process 500 in FIG. 5, process 600 in FIG. 6, process 1400 in FIG. 14, process 1500 in FIG. 15, and/or other processes for the frequency scan techniques described herein. Apparatus 1600 includes circuitry and may be one configuration of a user entity (e.g., a UE) or some other entity. In this specification and the appended claims, the term “circuitry” is construed as a structural term and not as a functional term. For example, circuitry may be an aggregate of circuit components, such as a multiplicity of integrated circuit components, in the form of processing and/or memory cells, units, blocks and the like, such as shown and described in FIG. 16.

Apparatus 1600 comprises a central data bus 1602 linking several circuits together. The circuits include at least one processor 1604, a receive circuit 1606, a transmit circuit 1608, and a memory 1610. Memory 1610 is in electronic communication with processor(s) 1604, so that processor(s) 1604 may read information from and/or write information to memory 1610. Processor(s) 1604 may comprise a general purpose processor, a central processing unit (CPU), a microprocessor, a digital signal processor (DSP), a controller, a microcontroller, a state machine, an application specific integrated circuit (ASIC), a programmable logic device (PLD), a field programmable gate array (FPGA), etc. Processor(s) 1604 may comprise a combination of processing devices, e.g., a combination of a DSP and a microprocessor, a plurality of microprocessors, one or more microprocessors in conjunction with a DSP core, or any other such configuration.

Receive circuit 1606 and transmit circuit 1608 may be connected to a radio frequency (RF) circuit (not shown in FIG. 16). Receive circuit 1606 may process and buffer received signals before sending the signals out to data bus 1602. Transmit circuit 1608 may process and buffer data from data bus 1602 before sending the data out of apparatus 1600. Processor(s) 1604 may perform the function of data management of data bus 1602 and further the function of general data processing, including executing the instructional contents of memory 1610. Transmit circuit 1608 and receive circuit 1606 may be external to processor(s) 1604 (as shown in FIG. 16) or may be part of processor(s) 1604.

Memory 1610 stores a set of instructions 1612 executable by processor(s) 1604 to implement the methods described herein. To implement process 1400 in FIG. 14, instructions 1612 may include code 1622 for performing a (full or partial) frequency scan for a plurality of frequency channels based on a center frequency and a bandwidth of each of the plurality of frequency channels, and code 1624 for identifying candidate frequency channels for acquisition based on the results of the frequency scan. To implement process 1500 in FIG. 15, instructions 1612 may include code 1632 for determining a band to scan, code 1634 for partitioning the band into a plurality of segments covering different portions of the band, code 1636 for determining received powers of a plurality of subcarriers within each of the plurality of segments, code 1638 for determining received powers of a plurality of raster frequencies within the band based on the received powers of the plurality of subcarriers within each of the plurality of segments, and code 1640 for performing a frequency scan based on the received powers of the plurality of raster frequencies within the band. Instructions 1612 may include other codes for other functions. Memory 1610 may also store prior acquisition information for wireless systems and/or frequency channels previously acquired by apparatus 1600, received powers for subcarriers and raster frequencies, candidate frequency channels, etc.

Instructions 1612 shown in memory 1610 may comprise any type of computer-readable statement(s). For example, instructions 1612 in memory 1610 may refer to one or more programs, routines, sub-routines, modules, functions, procedures, data sets, etc. Instructions 1612 may comprise a single computer-readable statement or many computer-readable statements.

Memory 1610 may be a RAM (Random Access Memory) circuit. Memory 1610 may be tied to another memory circuit (not shown), which may either be of a volatile or a nonvolatile type. As an alternative, memory 1610 may be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art. Memory 1610 may be considered to be an example of a computer-program product that comprises a computer-readable medium with instructions 1612 stored therein.

The previous description of the disclosure is presented to enable any person skilled in the art to make and use the disclosure. Details are set forth in the previous description for purpose of explanation. It should be appreciated that one of ordinary skill in the art would realize that the disclosure may be practiced without the use of these specific details. In other instances, well-known structures and processes are not elaborated in order not to obscure the description of the disclosure with unnecessary details. Thus, the present invention is not intended to be limited by the examples and designs described herein, but is to be accorded with the widest scope consistent with the principles and features disclosed herein.

The functions described herein may be implemented in hardware, software, firmware, or any combination thereof. If implemented in software, the functions may be stored as one or more instructions on a computer-readable medium. The term “computer-readable medium” or “computer program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the networks, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
performing a frequency scan for a plurality of frequency channels based on a center frequency and a bandwidth of each of the plurality of frequency channels; and
identifying candidate frequency channels for acquisition based on results of the frequency scan.

2. The method of claim 1, wherein the performing the frequency scan comprises measuring received power of each of the plurality of frequency channels based on the center frequency and the bandwidth of said each frequency channel.

3. The method of claim 2, wherein the measuring the received power of each of the plurality of frequency channels comprises determining the received power of each frequency channel based on received powers of a plurality of subcarriers within the bandwidth of the frequency channel.

4. The method of claim 1, wherein the performing the frequency scan comprises measuring received power of each of the plurality of frequency channels over a time interval determined based on a duplexing mode of said each frequency channel.

5. The method of claim 4, wherein the received power of a frequency channel associated with a time division duplexing mode is measured based further on an uplink-downlink configuration of the frequency channel.

6. The method of claim 1, wherein the bandwidth of each of the plurality of frequency channels is known from prior successful acquisition of said each frequency channel, and wherein the performing the frequency scan comprises measuring received power of each frequency channel based on the known bandwidth of the frequency channel.

7. The method of claim 1, wherein the bandwidth of each of the plurality of frequency channels is unknown, and wherein the performing the frequency scan comprises measuring received power of each frequency channel for each of a plurality of possible bandwidths for the frequency channel.

8. The method of claim 1, further comprising:
retrieving stored information for the plurality of frequency channels, the stored information comprising the center frequency and the bandwidth of each of the plurality of frequency channels determined from previous acquisition of said each frequency channel.

9. The method of claim 8, wherein the stored information further comprises a duplexing mode of each of the plurality of frequency channels, and wherein the frequency scan is performed based further on the duplexing mode of said each frequency channel.

10. The method of claim 8, wherein the stored information further comprises at least one of an uplink-downlink configuration for each frequency channel associated with a time division duplexing mode, a received power of each frequency channel obtained from prior acquisition of the frequency channel, or an elapsed time since last acquisition of each frequency channel.

11. The method of claim 1, further comprising:
determining the plurality of frequency channels based on a band to scan.

12. The method of claim 1, further comprising:
setting a gain of a low noise amplifier based on at least one initial power measurement for at least one of the plurality of frequency channels.

13. The method of claim 1, further comprising:
terminating the frequency scan when received power of any one of the plurality of frequency channels exceeds a threshold.

14. The method of claim 1, further comprising:
prioritizing the plurality of frequency channels based on at least one criterion; and
performing the frequency scan based on a priority of each of the plurality of frequency channels.

15. An apparatus for wireless communication, comprising:
means for performing a frequency scan for a plurality of frequency channels based on a center frequency and a bandwidth of each of the plurality of frequency channels; and
means for identifying candidate frequency channels for acquisition based on results of the frequency scan.

16. The apparatus of claim 15, wherein the means for performing the frequency scan comprises means for measuring received power of each of the plurality of frequency channels based on the center frequency and the bandwidth of said each frequency channel.

17. The apparatus of claim 15, wherein the bandwidth of each of the plurality of frequency channels is known from prior successful acquisition of said each frequency channel, and wherein the means for performing the frequency scan comprises means for measuring received power of each frequency channel based on the known bandwidth of the frequency channel.

18. The apparatus of claim 15, wherein the bandwidth of each of the plurality of frequency channels is unknown, and wherein the means for performing the frequency scan comprises means for measuring received power of each frequency channel for each of a plurality of possible bandwidths for the frequency channel.

19. The apparatus of claim 15, further comprising:
means for retrieving stored information for the plurality of frequency channels, the stored information comprising the center frequency and the bandwidth of each of the plurality of frequency channels determined from previous acquisition of said each frequency channel.

20. An apparatus for wireless communication, comprising:
circuitry configured to:
perform a frequency scan for a plurality of frequency channels based on a center frequency and a bandwidth of each of the plurality of frequency channels; and
identify candidate frequency channels for acquisition based on results of the frequency scan.

21. The apparatus of claim 20, wherein the circuitry is configured to measure received power of each of the plurality of frequency channels based on the center frequency and the bandwidth of said each frequency channel.

22. The apparatus of claim 20, wherein the bandwidth of each of the plurality of frequency channels is known from prior successful acquisition of said each frequency channel, and wherein the circuitry is configured to measure received power of each frequency channel based on the known bandwidth of the frequency channel.

23. The apparatus of claim 20, wherein the bandwidth of each of the plurality of frequency channels is unknown, and wherein the circuitry is configured to measure received power of each frequency channel for each of a plurality of possible bandwidths for the frequency channel.

24. The apparatus of claim 20, wherein the circuitry is configured to retrieve stored information for the plurality of frequency channels, the stored information comprising the center frequency and the bandwidth of each of the plurality of frequency channels determined from previous acquisition of said each frequency channel.

25. A computer program product, comprising:
a non-transitory computer-readable medium comprising:
code for causing at least one computer to perform a frequency scan for a plurality of frequency channels based on a center frequency and a bandwidth of each of the plurality of frequency channels; and
code for causing the at least one computer to identify candidate frequency channels for acquisition based on results of the frequency scan.

26. A method for wireless communication, comprising:
determining a band to scan, the band covering a plurality of raster frequencies;
partitioning the band into a plurality of segments covering different portions of the band;
determining received powers of a plurality of subcarriers within each of the plurality of segments;
determining received powers of the plurality of raster frequencies within the band based on the received powers of the plurality of subcarriers within each of the plurality of segments; and
performing a frequency scan based on the received powers of the plurality of raster frequencies within the band.

27. The method of claim 26, wherein the band is associated with a plurality of supported channel bandwidths, and wherein each segment has a bandwidth that is equal to or smaller than a largest supported channel bandwidth in the band.

28. The method of claim 26, wherein the plurality of raster frequencies within the band have a first frequency spacing, and wherein the plurality of subcarriers within each segment have a second frequency spacing different from the first frequency spacing.

29. The method of claim 26, wherein the determining the received powers of the plurality of raster frequencies within the band comprises:
determining a group of subcarriers, within at least one of the plurality of segments, associated with each of the plurality of raster frequencies, and
determining received power of each of the plurality of raster frequencies based on received powers of the group of subcarriers associated with said each raster frequency.

30. The method of claim 26, wherein the performing the frequency scan comprises measuring received power of each of a plurality of frequency channels within the band based on the received powers of the plurality of raster frequencies within the band.

31. The method of claim 30, wherein the measuring the received power of each of the plurality of frequency channels comprises measuring received power of a frequency channel, for each of a plurality of possible bandwidths for the frequency channel, based on the received powers of the plurality of raster frequencies within the band.

32. The method of claim 26, wherein the performing the frequency scan comprises:
determining a frequency channel and a bandwidth associated with a highest received power for each of the plurality of raster frequencies within the band, and
identifying candidate frequency channels for acquisition based on frequency channels and bandwidths associated with highest received powers within the band.

33. The method of claim 32, wherein the performing the frequency scan further comprises:
removing frequency channels corresponding to raster frequencies for which prior acquisition was unsuccessful, and
identifying the candidate frequency channels based on frequency channels corresponding to remaining raster frequencies within the band.

34. The method of claim 26, further comprising:
determining a gain of a low noise amplifier used for each of the plurality of segments; and
scaling the received powers of the plurality of subcarriers within each segment based on the gain of the low noise amplifier for the segment.

35. An apparatus for wireless communication, comprising:
means for determining a band to scan, the band covering a plurality of raster frequencies;
means for partitioning the band into a plurality of segments covering different portions of the band;
means for determining received powers of a plurality of subcarriers within each of the plurality of segments;
means for determining received powers of the plurality of raster frequencies within the band based on the received powers of the plurality of subcarriers within each of the plurality of segments; and
means for performing a frequency scan based on the received powers of the plurality of raster frequencies within the band.

36. The apparatus of claim 35, wherein the means for determining the received powers of the plurality of raster frequencies within the band comprises:
means for determining a group of subcarriers, within at least one of the plurality of segments, associated with each of the plurality of raster frequencies, and
means for determining received power of each of the plurality of raster frequencies based on received powers of the group of subcarriers associated with said each raster frequency.

37. The apparatus of claim 35, wherein the means for performing the frequency scan comprises means for measuring received power of each of a plurality of frequency channels within the band, for each of a plurality of possible bandwidths for said each frequency channel, based on the received powers of the plurality of raster frequencies within the band.

38. The apparatus of claim 35, wherein the means for performing the frequency scan comprises:
means for determining a frequency channel and a bandwidth associated with a highest received power for each of the plurality of raster frequencies within the band, and
means for identifying candidate frequency channels for acquisition based on frequency channels and bandwidths associated with highest received powers within the band.

39. An apparatus for wireless communication, comprising:
circuitry configured to:
determine a band to scan, the band covering a plurality of raster frequencies;
partition the band into a plurality of segments covering different portions of the band;
determine received powers of a plurality of subcarriers within each of the plurality of segments;
determine received powers of the plurality of raster frequencies within the band based on the received powers of the plurality of subcarriers within each of the plurality of segments; and
perform a frequency scan based on the received powers of the plurality of raster frequencies within the band.

40. The apparatus of claim 39, wherein the circuitry is further configured to:
determine a group of subcarriers, within at least one of the plurality of segments, associated with each of the plurality of raster frequencies; and
determine received power of each of the plurality of raster frequencies based on received powers of the group of subcarriers associated with said each raster frequency.

41. The apparatus of claim 39, wherein the circuitry is further configured to measure received power of each of a plurality of frequency channels within the band, for each of a plurality of possible bandwidths for said each frequency channel, based on the received powers of the plurality of raster frequencies within the band.

42. The apparatus of claim 39, wherein the circuitry is further configured to:
determine a frequency channel and a bandwidth associated with a highest received power for each of the plurality of raster frequencies within the band; and
identify candidate frequency channels for acquisition based on frequency channels and bandwidths associated with highest received powers within the band.

43. A computer program product, comprising:
a non-transitory computer-readable medium comprising:
code for causing at least one computer to determine a band to scan, the band covering a plurality of raster frequencies;
code for causing the at least one computer to partition the band into a plurality of segments covering different portions of the band;
code for causing the at least one computer to determine received powers of a plurality of subcarriers within each of the plurality of segments;
code for causing the at least one computer to determine received powers of the plurality of raster frequencies within the band based on the received powers of the plurality of subcarriers within each of the plurality of segments; and
code for causing the at least one computer to perform a frequency scan based on the received powers of the plurality of raster frequencies within the band.
